(19) United States
(12) Patent Application Publication
(10) Pub. No.: US 2014/0005955 A1
(43) Pub. Date: Jan. 2, 2014

(54) Methods and Apparatus for the Detection of Radioactive Materials

(71) Applicant: Mark Wilson, London (GB)

(72) Inventor: Mark Wilson, London (GB)

(73) Assignee: BABCOCK NUCLEAR LIMITED, London (GB)

(21) Appl. No.: 13/991,072

(22) PCT Filed: Dec. 5, 2011
(86) PCT No.: PCT/GB11/52396

§ 371 Date: Aug. 23, 2013

(30) Foreign Application Priority Data
Dec. 3, 2010 (GB) 1020402.9

(51) Int. Cl. G01T 1/00

(52) U.S. Cl. CPC G01T 1/00
USPC 702/23

(57) ABSTRACT

A method and apparatus use a first detector (7) sensitive to the interaction of cosmic rays and/or one or more types of particle generated by cosmic rays and a second detector (5a) sensitive to emissions from radioactive material to investigate a volume of material at the investigation location (1). By detecting signals from the first detector (7) during a first measurement period (W) and detecting signals from the first detector and/or second detector during the second measurement period (X), a ratio for their values can be obtained and used to indicate a possibility, wherein the possibility could be the presence of radioactive material associated with the volume of material; or the absence of radioactive material associated with the volume of material; or uncertainty as to whether there is radioactive material associated with the volume of material; or the presence of high atomic number material associated with the volume of material.

This invention concerns improvements in and relation to methods and apparatus for the detection of radioactive materials, for instance uranium. In particular, the invention is concerned with the detection of radioactive materials when they are in and/or are in proximity with other, matrix, materials. The invention is particularly aimed at radioactive materials which are low level emitters of neutrons and so are hard to distinguish from background sources of neutrons.

In various situations it is useful to be able to detect the presence of radioactive materials and/or fissile materials. Where the location of the material can be accessed to place a detector in proximity with it, then detection is fairly straightforward. However, there are many instances where the detector cannot be placed in physical proximity This may be because of other non-radioactive and/or non-fissile material, a matrix, around the radioactive material and/or fissile material. This may occur where the radioactive material is mixed with a non-radioactive matrix material within a container, for instance a drum containing waste. Such situations are more difficult to consider because of the shielding and/or attenuating effects of the matrix on the emissions from the radioactive/fissile material. The problem becomes even more pronounced where the matrix volume is high and/or the matrix materials are effective at shielding and/or the matrix materials themselves contribute to the background signal. This can be the case with larger containers such as iso-freight containers or deliberately shielded materials.

Attempts have been made to consider the radioactive/fissile material present by considering the neutrons arising from the material. The neutrons are generated at reasonable count rates and have sufficient energy to exit many matrix materials. However, where the radioactive/fissile material is present along side large masses of matrix material then significant neutron counts can be observed even where the neutrons from the radioactive/fissile material are low or not present. This is because the interaction of cosmic rays, more particularly particles generated by them, with the matrix gives rise to neutrons. The effect, known as the ship effect, is particularly pronounced where the matrix material includes high atomic number materials. High atomic number materials can be considered to be those numbered 72 and above, but even iron, 26, can have an effect.

Existing attempts to address this issue have focussed on upon complex mathematical models for the events detected and their use to distinguish between the source of the events, see for instance, “Combating Nuisance Alarms Caused by the Ship Effect in 3He Based Neutron Detection Radiation Portal Monitors” by Oliver et al., American Physical Society, 2007 Annual Meeting of the Division of Nuclear Physics, Oct. 10-13, 2007, which considered fissile material as giving Poisson distributions for their event frequency distribution and background events as being non-Poisson distributions. Such models and such manipulations give rise to complexity in the detection process and uncertainty in the results obtained.

Other attempts, such as “Passive Neutron Detection for Interdiction of Nuclear Material at Borders” by Kouzes et al., Nuclear Instruments and Methods in Physics Research Section A—Accelerators, Spectrometers Detectors and Associated Equipment, 584 (2-3): 383-400 11 Jan. 2008, have considered various design parameters, such as very large detectors, and the impact of various circumstances, but have problems with the limit of detection and/or high count time requirements.

WO2010/035003 provides for the detection of emissions from materials containing waste. To give a more accurate measure of the emissions, correction is applied for emissions which do not arise from the waste, but instead arise from cosmic rays, directly or indirectly. The cosmic background signal over time is deducted from the measured emissions to give the correction.

WO2007/107765 provides for the determination of density within a volume of material, or sections thereof, by considering the impact of the volume of material on cosmic rays, or particles or neutrons generated thereby, which pass through the material compared with those that do not.

It is amongst the potential aims of the invention to provide a method and/or apparatus for detecting the presence of radioactive/fissile material in a matrix of other materials. It is amongst the potential aims to make such a detection in a simple and reliable manner.

According to a first aspect of the invention there is provided a method for investigating a volume of material for radioactive material potentially associated therewith, the method comprising:
providing an investigation location;
providing a first detector, the interaction of cosmic rays and/or one or more types of particle generated by cosmic rays with the first detector causing the first detector to generate first signals;
providing a second detector, the interaction of one or more types of emission from radioactive material with the second detector causing the second detector to generate second signals;
providing a volume of material at the investigation location;
detecting a first signal from the first detector caused by the interaction of cosmic rays and/or one or more types of particle generated by cosmic rays with the first detector, starting a first measurement period at a first time relative to the first signal;
detecting first signals from the first detector and/or second signals from the second detector during the first measurement period;
starting a second measurement period at a second time;
detecting first signals from the first detector and/or second signals from the second detector during the second measurement period;
processing the signals detected during the first measurement period and the second measurement period to obtain their ratio, the value of the ratio indicating a possibility, wherein the possibility is one or more of the following possibilities:
   a) the presence of radioactive material associated with the volume of material; or
   b) the absence of radioactive material associated with the volume of material; or
   c) uncertainty as to whether there is radioactive material associated with the volume of material; or
   d) the presence of high atomic number material associated with the volume of material.

According to a second aspect of the invention there is provided a method for investigating a volume of material for of interest material potentially associated therewith, the method comprising:
providing an investigation location;
providing a first detector, the first detector generating first signals;
providing a second detector, the second detector generating second signals;
providing a volume of material at the investigation location;
detecting a first signal from the first detector and starting a first measurement period;
detecting first signals from the first detector and/or second signals from the second detector during the first measurement period;
starting a second measurement period at a second time;
detecting first signals from the first detector and/or second signals from the second detector during the second measurement period;
processing the signals detected during the first measurement period and the second measurement period to give a characteristic value, the value indicating one or more of the possible combinations of radioactive material and the volume of material and/or high atomic number material and the volume of material.

The of interest material may be a radioactive material and/or may be a material having one of more other properties. The one or more other properties may be the atomic number of the material, for instance an atomic number above 26 or above 39 or above 58.

The method may provide that the first detector is sensitive to interaction with cosmic rays and/or one or more types of particle generated by cosmic rays to cause the first detector to generate first signals. The cosmic rays may be detected directly and/or indirectly.

The method may provide that the second detector is sensitive to interaction with one or more types of emission from radioactive material to cause the second detector to generate second signals. The one or more types of emission may be detected directly and/or indirectly.

The method may provide for the detection of a first signal from the first detector caused by the interaction of cosmic rays and/or one or more types of particle generated by cosmic rays with the first detector. The method may provide for starting a first measurement period at a first time relative to the first signal.

The method may provide that the processing of the signals detected during the first measurement period and the second measurement period is used to obtain their ratio. The ratio may be the characteristic value. The method may provide that the value of the ratio indicates one or more possibilities. The one or more possibilities may include one or more of the following possibilities: the presence of radioactive material associated with the volume of material; or the absence of radioactive material associated with the volume of material; or uncertainty as to whether there is radioactive material associated with the volume of material; or the presence of high atomic number material associated with the volume of material.

According to a third aspect of the invention there is provided apparatus for investigating a volume of material for radioactive material potentially associated therewith, the apparatus comprising:

an investigation location, at which, in use, a volume of material is provided;

a first detector, the interaction of cosmic rays and/or one or more types of particle generated by cosmic rays with the first detector causing the first detector to generate first signals;

a second detector, the interaction of one or more types of emission from radioactive material with the second detector causing the second detector to generate second signals;

electronics and/or computer software for handling a first signal from the first detector caused by the interaction of cosmic rays and/or one or more types of particle generated by cosmic rays with the first detector, electronics and/or computer software for starting a first measurement period at a first time relative to the first signal;

electronics and/or computer software for detecting first signals from the first detector and/or second signals from the second detector during the first measurement period;

electronic and/or computer software for starting a second measurement period at a second time;

electronics and/or computer software for detecting first signals from the first detector and/or second signals from the second detector during the second measurement period;

one or more processors for the signals detected during the first measurement period and the second measurement period to obtain their ratio, the value of the ratio indicating a possibility, wherein the possibility is one or more of the following possibilities:
a) the presence of radioactive material associated with the volume of material; or
b) the absence of radioactive material associated with the volume of material; or
c) uncertainty as to whether there is radioactive material associated with the volume of material; or
d) the presence of high atomic number material associated with the volume of material.

According to a fourth aspect of the invention there is provided apparatus for investigating a volume of material for of interest material potentially associated therewith, the apparatus comprising:

an investigation location;

a first detector, the first detector providing first signals;

a second detector, the second detector providing second signals;

electronics and/or computer software for handling a first signal from the first detector, electronics and/or computer software for starting a first measurement period;

electronics and/or computer software for detecting first signals from the first detector and/or second signals from the second detector during the first measurement period;

electronic and/or computer software for starting a second measurement period at a second time;

electronics and/or computer software for detecting first signals from the first detector and/or second signals from the second detector during the second measurement period;

one or more processors for the signals detected during the first measurement period and the second measurement period to give a characteristic value, the value indicating one or more of the possible combinations of radioactive material and the volume of material and/or high atomic number material and the volume of material.

The of interest material may be a radioactive material and/or may be a material having one of more other properties. The one or more other properties may be the atomic number of the material, for instance an atomic number above 26 or above 39 or above 58.

The apparatus may provide a first detector, the first detector being sensitive to interaction with cosmic rays and/or one or more types of particle generated by cosmic rays to cause the first detector to generate first signals. The cosmic rays may be detected directly and/or indirectly.

The apparatus may provide that a second detector, the second detector being sensitive to interaction with one or more types of emission from radioactive material to cause the second detector to generate second signals. The one or more types of emission may be detected directly and/or indirectly.

The apparatus may provide electronics and/or computer software for the detection of a first signal from the first detector caused by the interaction of cosmic rays and/or one or more types of particle generated by cosmic rays with the first detector. The apparatus may provide electronics and/or computer software for starting a first measurement period at a first time relative to the first signal.

The apparatus may provide electronics and/or computer software for processing of the signals detected during the first measurement period and the second measurement period is used to obtain their ratio. The ratio may be the characteristic value. The apparatus may provide that the value of the ratio indicates one or more possibilities. The one or more possibilities may include one or more of the following possibilities: the presence of radioactive material associated with the volume of material; or the absence of radioactive material associated with the volume of material; or uncertainty as to whether there is radioactive material associated with the volume of material; or the presence of high atomic number material associated with the volume of material.

The first and/or second and/or third and/or fourth aspects of the invention may include any of the features, options or possibilities set out elsewhere within this document, including from the following.

The volume of material may be provided within a container. The container may be of metal. The container may be of plastics. The container may be sealed. The container may be a drum. The container may be a shipping container, such as a half ISO-freight or ISO-freight container. Preferably possibilities are indicated without opening the container.

The container may have a volume greater than 50 litres, more preferably greater than 1000 litres, still more preferably greater than 10000 litres. The container may have a width greater than 5 feet and/or height greater than 5 feet and/or length greater than 8 feet, for instance greater than 15 feet or greater than 35 feet. The container may be rigid.

The volume of material may include one or more of paper, plastics, wood, rubber, glass, concrete, soil, metal or liquids. The volume of material may include high atomic number materials, for instance with an atomic number above 26 or above 39 or above 58. The volume of material may include one or more of lead or tungsten.

The mass of the material may be measured as a part of the method. The density of the material may be measured as a part of the method.

The radioactive material may include one or more isotopes of one or more elements. The radioactive material may include plutonium. In particular, the radioactive material may include uranium. The radioactive material may include one or more alpha particle emitters and/or beta particle emitters and/or gamma ray emitters. It is preferred that the radioactive material include one or more neutron emitters.

The investigation location may be provided between one or more first detectors and one or more opposing first detectors. The investigating location may be provided between one or more second detectors and one or more opposing second detectors.

The investigating location may be provided with one or more first detectors below the investigating location. The investigating location may be provided with one or more second detectors below the investigating location.

The investigating location may be provided with one or more first detectors above the investigating location. The investigating location may be provided with one or more second detectors above the investigating location.

The investigating location may be provided with one or more moveable first detectors and/or moveable second detectors. The detectors may be moveable to allow the introduction of the volume of material to the investigating location and/or to allow the removal of the volume of material from the investigating location.

The investigation location may be a vehicle bearing surface, such as a road.

The second detector may produce a signal on interacting with one or more of an alpha particle, a beta particle, a gamma ray, a neutron, an X-ray or a fission fragment. Preferably the second detector is a neutron detector. The second detector may be a He-3 gas proportional detector, although many other neutron detector types can be used.

A plurality of second detectors may be provided. Preferably at least 8 second detectors are provided and more preferably at least 40 second detectors are provided. Preferably second detectors are positioned to extend across at least 50% of the width of the volume of material and/or investigation location. Preferably second detectors are positioned so as to extend along at least 50% of the height of the volume of material and/or investigation location. The second detector may be provided within a shield. The shield may be of lead or included lead. More preferably the shield is of cadmium or includes cadmium and/or is a polymer or includes a polymer. The shield may be configured to reduce or eliminate one or more types of emission reaching the second detector other than from the investigation location.

The second signals are preferably conveyed from the second detector to a processor and/or data storage device.

The second detector may be of a type which is different to the first detector.

Preferably the first detector is a charged particle detector. The first detector may produce a signal on interacting with a proton, an electron or an atomic nuclei, particularly where that is a cosmic ray and/or is generated by the interaction of a cosmic ray with the Earth's atmosphere. The first detector may produce a signal on interacting with a muon or meson, particularly where generated, directly and/or indirectly, by the interaction of a cosmic ray with the earth's atmosphere. The first detector may produce a signal on interacting with a neutron, particularly where generated by a cosmic ray and/or where generated by a particle generated by a cosmic ray. The first detector preferably does not produce a signal on interacting with one or more of an alpha particle, a beta particle, a gamma ray, a neutron, an X-ray or a fission fragment, when those are produced by a radioactive decay process, particularly when arising from the investigation location and/or volume of material. The first detector may produce a signal on interacting with a cosmic ray and/or a particle generated by an interaction involving a cosmic ray and/or a particle generated by an interaction involving a particle generated by an interaction involving a cosmic ray. The first detector may be a scintillation based detector, such as a plastics scintillator and/or slab scintillator. Preferably the first detector or detectors are sensitive to a known proportion of the cosmic rays and/or particles generated by cosmic rays and/or further particles generated by particles generated by cosmic rays incident on the investigation location.

A plurality of first detectors may be provided. Preferably at least 4 first detectors are provided. Preferably the first detector or detectors are positioned to extend across at least 50% of the width of the volume of material and/or investigation location. Preferably the first detector or detectors are positioned so as to extend along at least 50% of the height of the volume of material and/or investigation location.

One or more of the first detector may be provided further from the investigating than one or more of the second detectors. For instance, a first detector may be provided adjacent a second detector, but with the second detector between the first detector and the investigation location.

The first signals are preferably conveyed from the first detector to a processor and/or data storage device.

The data storage device may be used to record the detector which is the origin of a signal. The data storage device may be used to record the reference time and/or a relative clock time for a signal from a detector. The time may be noted by a time stamper.

The data storage device may be used to provide information on the second signals and/or first signals to a processor.

The first signal from the first detector caused by the interaction of cosmic rays and/or one or more types of particle generated by cosmic rays with the first detector may be a trigger signal. The trigger signal may start the first measurement period.

The first measurement period may start at the time of the first signal. The first measurement period may start a fixed time after the time of the first signal. The first measurement period may start before the time of the first signal. The first time period may have a fixed duration. The duration may be between 5 microseconds and 350 microseconds. The duration may be between 50 and 350 microseconds, for instance 250 microseconds +/−20%. The signals detected during the first measurement period may be equated to the cosmic ray caused signals and radioactive material in the volume of material caused signals and background caused signals. The signals detected during the first measurement may be equated to signals caused by neutrons caused by cosmic rays and neutrons generated by radioactive material in the volume of material and neutrons caused by background events.

The second measurement period may start at a second time relative to the first signal. The second measurement period may start at a second time relative to a trigger signal. The second measurement period may be provided before the first measurement period. The first measurement period may start before the time of the first signal. The second measurement period may be provided after the first measurement period. The second measurement period is preferably at a different time to the first measurement period.

Preferably no part of the first measurement period corresponds to any part of the second measurement period. The second measurement period may start a fixed time after the time of the first signal. The second measurement period may have a fixed duration. The duration may be between 5 microseconds and 10000 microseconds. The duration may be between 500 and 5000 microseconds, for instance 4000 microseconds +/−20%. The signals detected during the second measurement period may be equated to the radioactive material in the volume of material caused signals and background caused signals. The signals detected during the second measurement may be equated to signals caused by neutrons caused by cosmic rays and neutrons generated by radioactive material in the volume of material and neutrons caused by background events.

The processing of the signals detected during the first measurement period and the second measurement period may provide a value for their ratio. The ratio may be of the first signal value to the second signal value. The ratio may be of the second signal value to the first signal value. The signals during the first and second measurement period may be expressed in the same units. The units may be count or count rate.

The ratio may be considered together with one or more other values. The one or more other values may be or include a value, such as the count or count rate, for the second measurement period. The ratio may be considered together with the value by considering the value for the ratio against the other value obtained for the second measurement period, for instance as a plot of one against the other. A plot value may be obtained by considering the value for the ratio against the other value obtained for the second measurement period. The position of the plot value may establish the possibility applying. The position of the plot may be considered against one or more bands or areas. A band or area may correspond to one of the possibilities. A band or area may apply for the possibility of the presence of radioactive material associated with the volume of material. A band or area may apply for the possibility of the absence of radioactive material associated with the volume of material. A band or area may apply for the possibility of the presence of radioactive material associated with the volume of material. A band or area may apply for the possibility of uncertainty as to whether there is radioactive material associated with the volume of material.

The observed ratio and/or value and/or plot may be compared with an expected ratio and/or value and/or plot. The comparison may provide an indication, for instance a warning, where the observed ratio and/or value and/or plot exceeds the expected and/or is below the expected, or more preferably where it exceeds the expected plus a margin and/or is below the expected minus a margin.

The ratio and/or the one or more other values, such as for the second measurement period, and/or the plot and/or one or more of the bands and/or one or more of the areas corresponding to a possibility may vary according to a variable. The variation according to the variable may be a correction. The variation and/or correction may be in respect of the pressure detected, for instance during the first and/or second measurement period. The variation and/or correction may be in respect of the density detected for the volume of material and/or part thereof. The variation and/or correction may be in respect of the mass of the volume of material and/or part thereof. Two or more variations and/or corrections may be applied.

The method and/or apparatus may include a determination of the mass of the volume of material, for instance by means of a weighing device. The mass may be determined at the investigation location and/or elsewhere. The mass may be that of the whole of the volume of material and/or a part of the volume of material, for instance the volume of material may be divided into a number of sections.

The mass may be used to correct one or more of the values used in the method and/or may be used to determine one or more of the values used in the method, for instance the band and/or areas for a value or for a ratio which are used in the determination of the possibility.

The observed mass may be compared with an expected mass. The comparison may provide an indication, for instance a warning, where the observed mass exceeds the expected mass, or more preferably where it exceeds the expected mass plus a margin.

The observed first measurement period result may be compared with an expected first measurement period result, particularly for a given mass. The comparison may provide an indication, for instance a warning, where the observed exceeds the expected, or more preferably where it exceeds the expected plus a margin, and/or where the observed is below the expected, or more preferably where the observed is below the expected minus a margin.

The observed second measurement period result may be compared with an expected second measurement period result, particularly for a given mass. The comparison may provide an indication, for instance a warning, where the observed exceeds the expected, or more preferably where it exceeds the expected plus a margin, and/or where the observed is below the expected, or more preferably where the observed is below the expected minus a margin.

The method and/or apparatus may include a determination of the density of the volume of material, for instance by a weighing device and/or volume measuring device. The density may be determined at the investigation location and/or elsewhere. The density may be that of the whole volume of material and/or a part of the volume of material, for instance the volume of material may be divided into a number of sections.

The density may be determined by the method for determining density detailed in WO2007/107765, the contents of which are incorporated herein by reference with respect to that density determination.

The density may be used to correct one or more of the values used in the method and/or may be used to determine one or more of the values used in the method, for instance the band and/or areas for a value or for a ratio which are used in the determination of the possibility.

The observed density may be compared with an expected density. The comparison may provide an indication, for instance a warning, where the observed density exceeds the expected density, or more preferably where it exceeds the expected density plus a margin.

The observed first measurement period result may be compared with an expected first measurement period result, particularly for a given density. The comparison may provide an indication, for instance a warning, where the observed exceeds the expected, or more preferably where it exceeds the expected plus a margin, and/or where the observed is below the expected, or more preferably where the observed is below the expected minus a margin.

The observed second measurement period result may be compared with an expected second measurement period result, particularly for a given density. The comparison may provide an indication, for instance a warning, where the observed exceeds the expected, or more preferably where it exceeds the expected plus a margin, and/or where the observed is below the expected, or more preferably where the observed is below the expected minus a margin.

In an alternative consideration, the consideration may be made in two stages. The stages may be provided sequentially or simultaneously.

In a first stage, the possibilities with respect to the mass of high atomic number material may be determined. This may be the determination of the presence of such material above a level and/or a quantification of the mass present. In the first stage, materials may be classified as having and/or lacking a mass of high atomic number material within them. In the first stage, the consideration may be of the ratio of the signals in the first measurement period to those of the second measurement period or vice versa. The ratio may be compared with one or more known ratio values to establish the one of the possibilities applying. The known ratio values may include one or more ratio values known to give one of the possibilities, for instance the presence of a mass of high atomic number material associated with the volume of material. The known ratio values may include one or more ratio values known to give one of the other possibilities, for instance the absence of a high atomic number material associated with the volume of material. The known ratio values may include one or more ratio values known to give one of the other possibilities, for instance uncertainty as to whether there is a high atomic number material associated with the volume of material. The known ratio values may be expressed as a threshold value, with a value exceeding the threshold or a value less than the threshold giving one of the possibilities, for instance the presence of a high atomic number material associated with the volume of material. The known ratio values may be expressed as a threshold value, with a value less than the threshold or a value exceeding the threshold giving one of the other possibilities, for instance the absence of a high atomic mass material associated with the volume of material. The known ratio values may be expressed as a band of values, with a value in the band of values giving one of the other possibilities, for instance uncertainty as to whether there is a high atomic number material associated with the volume of material.

In a second stage, the possibilities with respect to the mass and/or activity of radioactive material present may be determined. This may be the determination of the presence of such material above a level and/or quantification of the mass present. In the second stage, materials may be classified as having and/or lacking a mass of radioactive material within them. In the second stage, the consideration may be of the value of the other value, for instance the count or count rate for the second measurement period. The other value may be compared with one or more known other values to establish the one of the possibilities applying. The known other values may include one or more other values known to give one of the possibilities, for instance the presence of radioactive material associated with the volume of material. The known other values may include one or more other values known to give one of the other possibilities, for instance the absence of radioactive material associated with the volume of material. The known other values may include one or more other values known to give one of the other possibilities, for instance uncertainty as to whether there is radioactive material associated with the volume of material. The known other values may be expressed as a threshold value, with a value exceeding the threshold or a value less than the threshold giving one of the possibilities, for instance the presence of radioactive material associated with the volume of material. The known other values may be expressed as a threshold value, with a value less than the threshold or a value exceeding the threshold giving one of the other possibilities, for instance the absence of radioactive material associated with the volume of material. The known other values may be expressed as a band of values, with a value in the band of values giving one of the other possibilities, for instance uncertainty as to whether there is radioactive material associated with the volume of material.

The ratio and/or the one or more other values, such as for the second measurement period, and/or the plot and/or one or more of the bands and/or one or more of the areas corresponding to a possibility may vary according to a variable. The variation according to the variable may be a correction. The variation and/or correction may be in respect of the pressure detected, for instance during the first and/or second measurement period. The variation and/or correction may be in respect of the density detected for the volume of material and/or part thereof. The variation and/or correction may be in respect of the mass of the volume of material and/or part thereof. Two or more variations and/or corrections may be applied.

Particularly in the first stage, the one or more known ratio values may be obtained via a calibration process. The one or more known ratio values may be obtained with the investigation location empty. The one or more known ratio values may be obtained with a calibration volume present in the investigation location. The one or more known ratio values may be a value or a band or range of values. The one or more known ratio values may be provided to the instrument. The calibration process may calibrate for variations in pressure, for instance that may be observed during the first and/or second measurement period. The calibration process may calibrate for variations in density of the volume of material, for instance that may be observed with different volumes of material. The calibration process may calibrate for variations in mass of the volume of material, for instance that may be observed with different volumes of material.

Where the ratio is of the value for the signals during the first measurement period divided by the value for the signals during the second measurement period, then compared with a known ratio value, then one or more of the following variations in the ratio may be considered and/or the variation may be consider to indicate one or more of the following:

a) the ratio is less than the known ratio, potentially with this considered to indicate the absence of a high atomic number material associated with the volume of material; or

b) the ratio is more than the known ratio, potentially with this considered to indicate the presence of a high atomic number material associated with the volume of material; or

c) the ratio matches the known ratio, potentially with this considered to indicate uncertainty as to whether there is a high atomic number material associated with the volume of material.

Where the ratio is of the value for the signals during the second measurement period divided by the value for the signals during the first measurement period, then compared with a known ratio value, then one or more of the following variations in the ratio may be consider and/or the variation may be consider to indicate one or more of the following:

a) the ratio is more than the known ratio, potentially with this considered to indicate the absence of a high atomic number material associated with the volume of material; or

b) the ratio is less than the known ratio, potentially with this considered to indicate the presence of a high atomic number material associated with the volume of material; or

c) the ratio matches the known ratio, potentially with this considered to indicate uncertainty as to whether there is a high atomic number material associated with the volume of material.

Particularly in the second stage, the one or more known other values may be obtained via calibration process. The one or more known other values may be obtained with the investigation location empty. The one or more known other values may be obtained with a calibration volume present in the investigation location. The one or more known other values may be a value or a band or range of values. The one or more known other values may be obtained by adding a value on to the values obtained with the investigating location empty. The one or more known other values may be provided to the instrument.

Where the other value is the value for the signals during the second measurement period, then when compared with a known other value one or more of the following variations in the other value may be consider and/or the variation may be consider to indicate one or more of the following:

a) the other value is less than the known other value, potentially with this considered to indicate the absence of a radioactive material associated with the volume of material;

b) the other value is greater than the known other value, potentially with this considered to indicate the presence of a radioactive material associated with the volume of material;

c) the other value matches the known other value, potentially with this considered to indicate uncertainty as to whether there is a radioactive material associated with the volume of material.

If the possibility is uncertainty as to whether there is a high atomic number material associated with the volume of material and/or as to whether there is a radioactive material associated with the volume of material, then one or more further method steps may be conducted. The one or more further method steps may include one or more of the following:

i) detecting for a further time period first signals from the first detector and/or second signals from the second detector during a further first measurement period; or

ii) starting a further second measurement period at a second time;

iii) detecting first signals from the first detector and/or second signals from the second detector during the further second measurement period;

iv) processing the signals detected during the further first measurement period and the further second measurement period to obtain their further ratio, the further value of the further ratio indicating one or more of the following possibilities: the presence of radioactive material associated with the volume of material; or the absence of radioactive material associated with the volume of material; or uncertainty as to whether there is radioactive material associated with the volume of material.

The further time period may be a longer time period that used in the first operation of the method. The first operation of the method may use a time period of between 20 and 250 seconds, such as 100 seconds +/−10%. The longer time period may be between 500 and 5000 seconds, such as 1000 seconds +/−10%.

The processor may consider the second signals and/or first signals offline and/or after completion of the collection of the second signals and/or first signals. The processor may consider the second signals and/or first signals online and/or before the completion of the collection of the second signals and/or first signals.

The processor may provide one or more processed signals.

Based upon the possibility identified, one or more decisions may be made about the volume of material and/or one or more actions may be applied to the volume of material. The decision may be to allow the volume of material past a location. The decision may be to detain the volume of material at a location. The decision may be to conduct one or more further investigations. The further investigations may include a repeat of the method, for instance with a longer measurement time and/or higher count, and/or one or more alternative investigations. The action may be to detain the volume of material at a location. The action may be to conduct one or more further investigations. The further investigations may include a repeat of the method, for instance with a longer measurement time and/or higher count, and/or one or more alternative investigations.

Various embodiments of the invention will now be described, by way of example only, and with reference to the accompanying drawings in which:

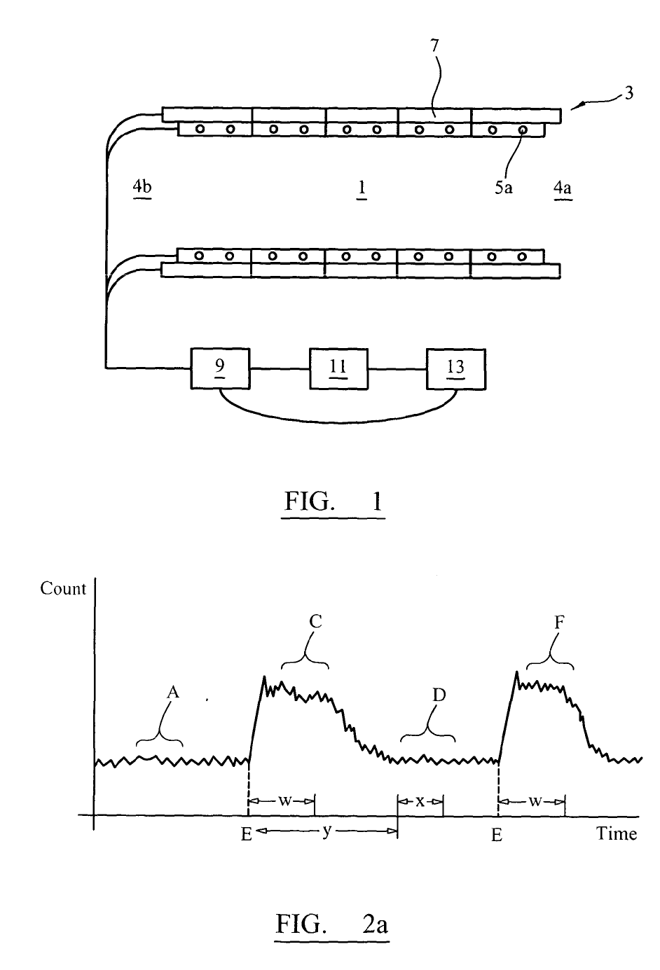

FIG. 1 is a schematic illustration of an instrument according to an embodiment of the invention;

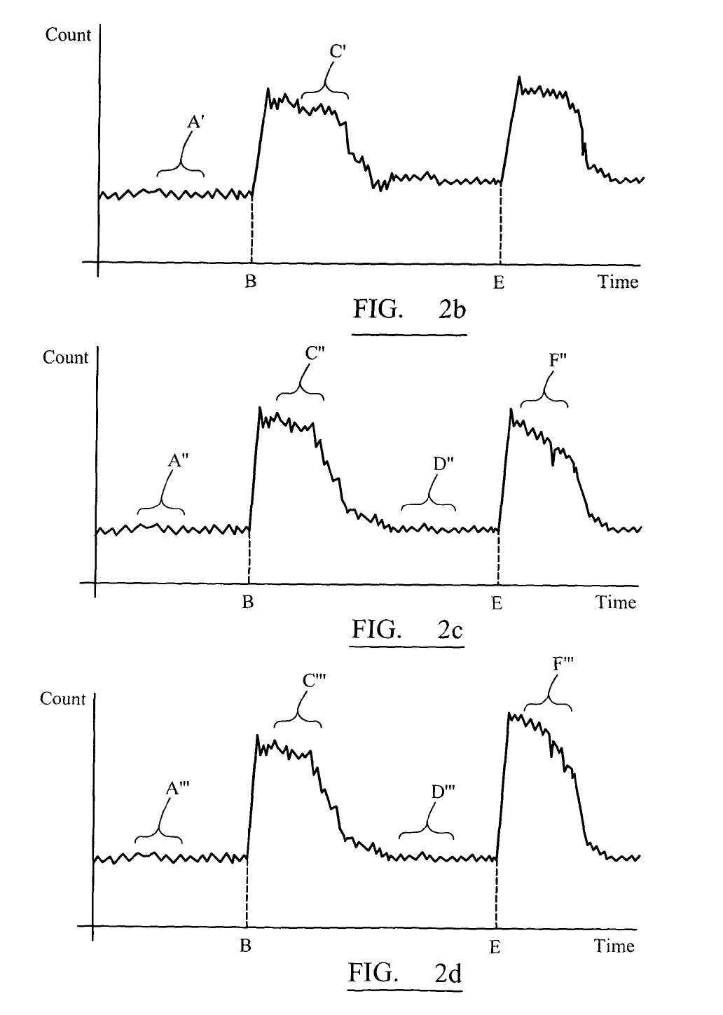

FIG. 2a shows schematically the variation in neutron count with time for an empty detection location;

FIG. 2b shows schematically the variation in neutron count with time for a very low mass of low level enriched uranium at the detection location;

FIG. 2c shows schematically the variation in neutron count with time for a mass of lead at the detection location;

FIG. 2d shows schematically the variation in neutron count with time for a small mass of low level enriched uranium and a mass of lead at a detection location;

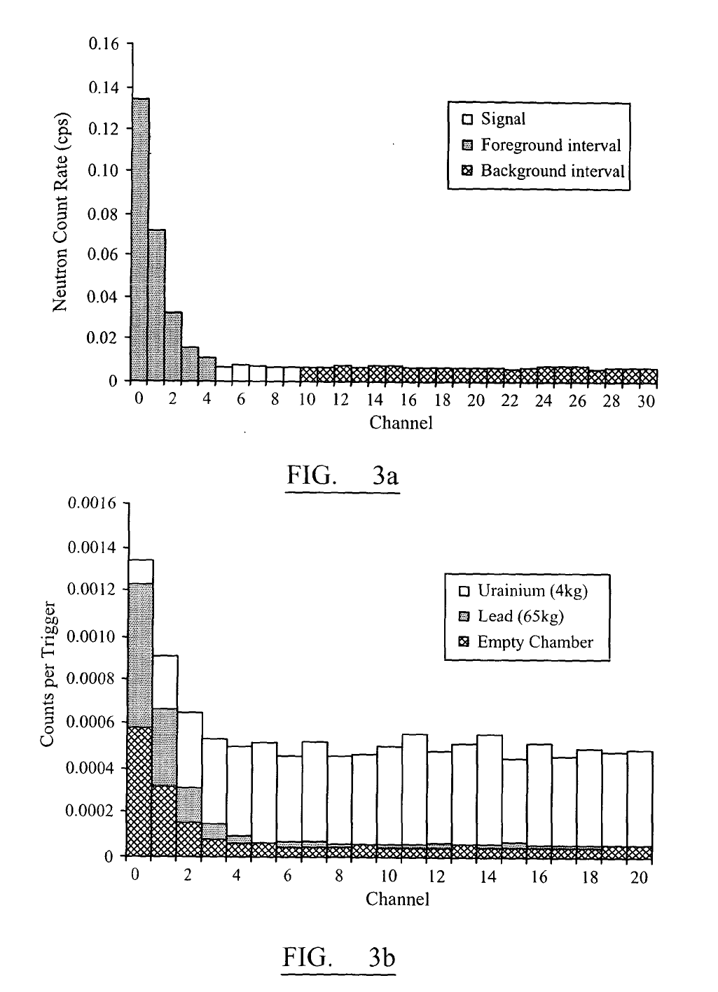

FIG. 3a shows the division of the neutron count with time from experimental measurements into the first, foreground, measurement time period and the second, background, measurement period;

FIG. 3b shows the variation in neutron count per trigger across the channels taken from experimental measurements with an empty chamber, 65 kg of lead and 4 kg of uranium;

FIG. 3c shows the variation in neutron count rate across the channels taken from experimental measurements with an empty chamber, two lead blocks, four lead blocks and a 4 kg uranium block;

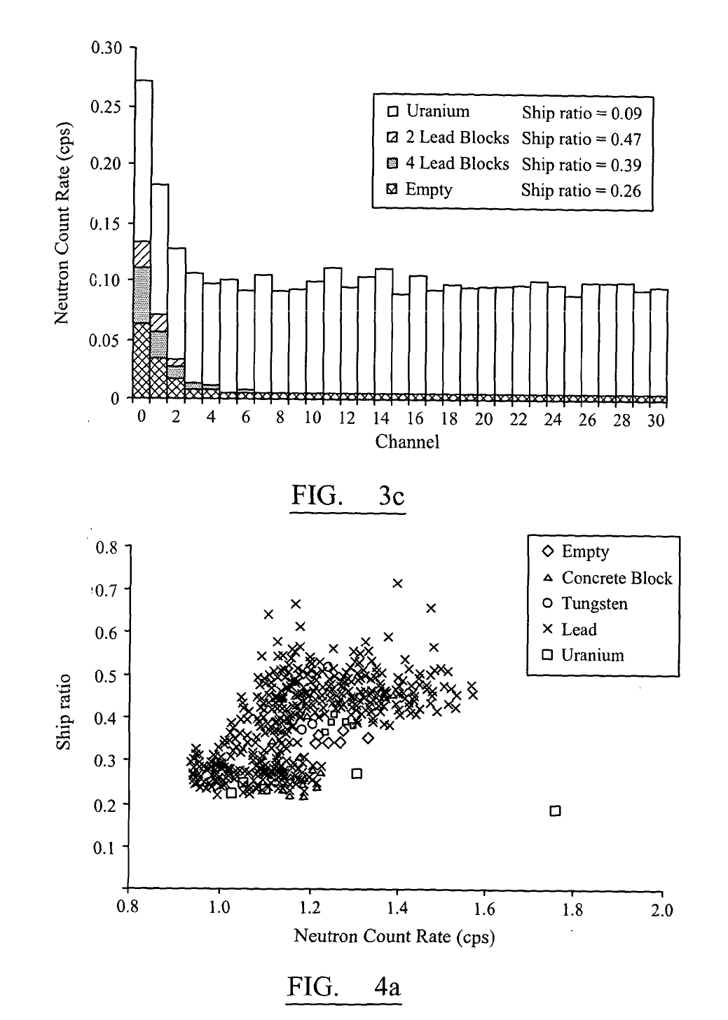

FIG. 4a shows the ratio of two counts, designated by the applicant the “ship” ratio, against neutron count rate for a variety of materials provided in the detection location;

FIG. 4b shows the ratio of two counts , designated by the applicant as the “ship” ratio, against neutron count rate for some other materials in the detection location;

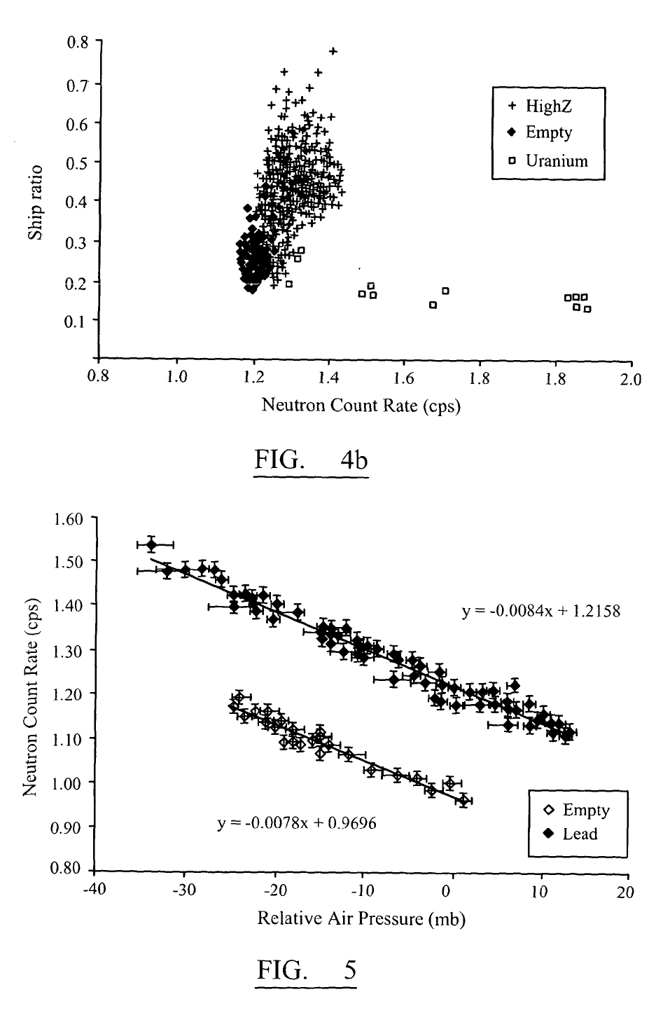

FIG. 5 shows the variation in observed neutron count rate against pressure with the empty detection location and with the detection location provided with a mass of lead;

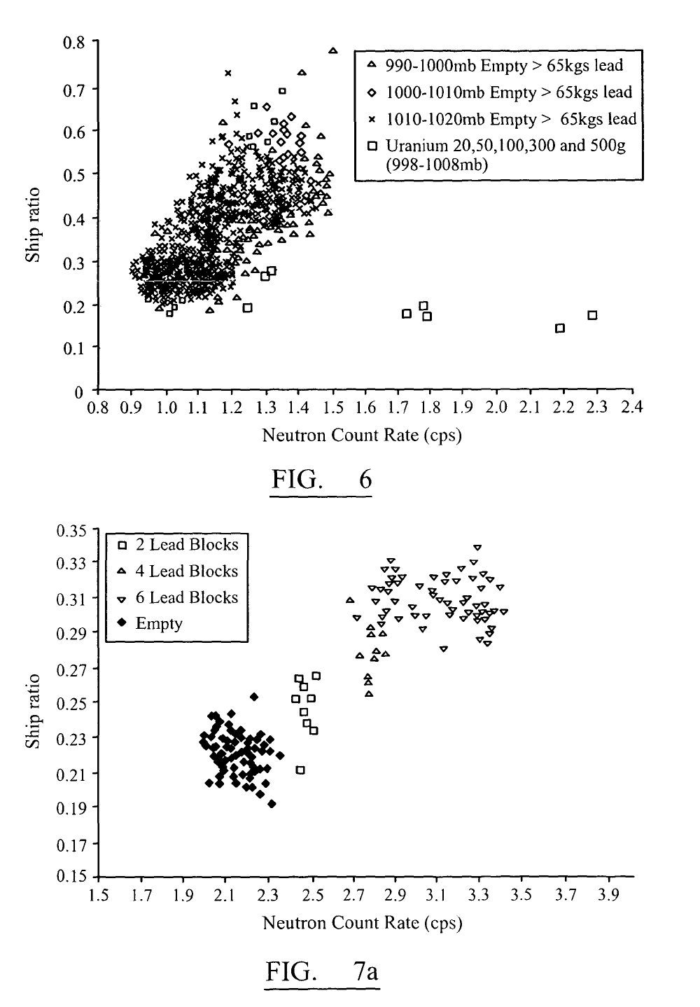

FIG. 6 shows the ratio of two counts, designated by the applicant the “ship” ratio, against neutron count rate for a variety of materials provided in the detection location, corrected for variation in atmospheric pressure;

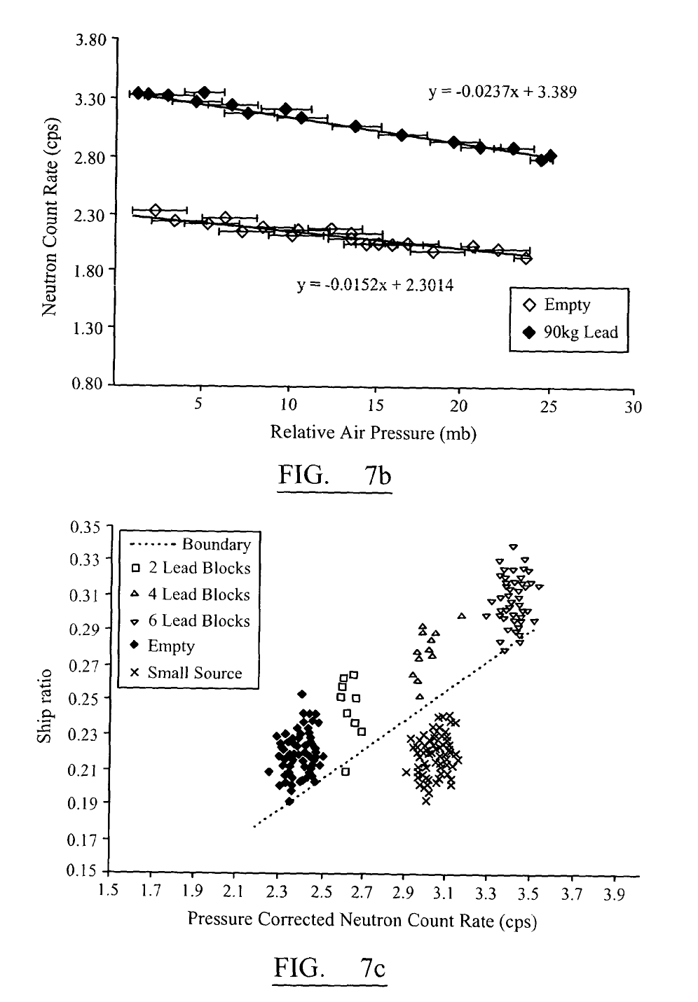

FIG. 7a shows the ratio of two counts, designated by the applicant the “ship” ratio, against neutron count rate for a variety of materials provided in the detection location;

FIG. 7b shows the variation in observed neutron count rate against pressure with the empty detection location and with the detection location provided with a mass of lead; and

FIG. 7c shows the same data as used in FIG. 7a, but corrected for variation in atmospheric pressure.

The present invention makes use of neutron detection to identify the presence of and/or quantity of radioactive material present. The approach is particularly concerned with detection when the radioactive material is present in association with matrix materials, which are not radioactive. Such situations can occur in a large number of different situations; some of which are described below.

FIG. 1 provides a schematic plan view of an instrument according to the invention. As shown in FIG. 1, a detection location 1 is shown with a series of neutron detector panels 3 positioned around it on two sides. The detection location 1 can be entered through space 4a and left through space 4b. The neutron detector panels 3 are in the form of tubular pressurised He3 thermal neutron detectors 5 with the scintillators 7 outside of those relative to the detection location 1. The He3 detectors 5 are used to detect the spontaneous fission generated neutrons. The scintillator is a plastics scintillator and is used to detect the muons, mesons and other species generated directly or indirectly by cosmic rays. The scintillators 7 may be sensitive to neutrons generated by spontaneous fission of the radioactive material. It is preferred that the scintillators are not sensitive to neutrons generated by the cosmic rays directly or indirectly.

The detector panels 3 shown can be supplemented by detector panels above and particularly below the detection location 1.

Upon detecting a neutron, the detector panel 3 generates a signal from the respective detector which is amplified, signal conditioned and then fed to detection electronics 9. The detection electronics 9 can be connected to processing electronics 11 for real time processing of the signals, and/or the data can be recorded for later use. The detector which is the source of the signal and its time are known for subsequent processing. A user interface 13 is also provided.

The neutron detector panels 3 are sensitive to neutrons arising from radioactive/fissile material in a container placed within the detection location 1 and to neutrons in the background from radioactive sources. The neutron detector panels 3 are also sensitive to neutrons emitted by the of interest material, particularly the radioactive material, including those generated directly or indirectly by cosmic rays.

Cosmic rays are high-energy particles that enter the atmosphere of the Earth from space, having arisen from non-Earth sources. These include cosmic rays arising from the Sun and still higher energy cosmic rays from galactic sources. The cosmic rays are mostly pieces of atoms, that is protons, electrons and atomic nuclei (which have had all of the surrounding electrons stripped from them). As a consequence these particles are all charged particles. The term ray is to an extent misleading as the particles arrive and interact individually with the atmosphere and detectors.

When a cosmic ray particle enters the earth's atmosphere, it collides with molecules in the atmosphere, mainly oxygen and nitrogen or eventually a liquid or solid object. This interaction produces a cascade of generated particles. The generated particles include protons, muons (generated directly and as decay products) and neutrons (generated directly or by the action of other generated particles, such as protons and muons).

Where the interaction occurs near the instrument, these particles, or at least the neutron part thereof, may then interact with a detector panel 3. The energy of the cosmic ray particle means that an extremely large number of generated particles can be generated in this way. The random nature of the collision process, and the fact that the products of the collision process remain within a cone extending directly away from the collision point and having a narrow angle (a degree or so), means that the presence or absence of such bursts of generated particles at any one point in time can be highly localised. The occurrence of such interactions means that bursts of signals tend to occur.

As well as the particles (including neutrons) generated directly by the cosmic ray in this first type of interaction, those particles generated by the cosmic ray in the first type of interaction may also interact with the atmosphere or a liquid or solid object. This second type of interaction provides further particles (including neutrons) generated by the cosmic ray. These too are susceptible to detection when they are generated near the instrument.

The shielding 15 for the detection location 1 tends to exclude neutrons generated by cosmic rays and by particles generated by cosmic rays, where the neutrons arise outside the detection location 1. However, their generation inside the detection location 1 is perfectly possible.

The principles of the approach used are now shown be reference to the impact of a series of known material types which are placed at the detection location 1.

In FIG. 2a the neutron response with time for the detector panels 3 is shown. The neutron response can be based upon the count or count rate observed by the thermal neutron detectors 5, without or with the addition of the neutron response detected by the scintillators 7. The response has a “background” level, A. After the time B at which a trigger event occurs, the neutron response signal has a higher “foreground” level, C. The trigger event may be a muon, proton or other cosmic ray triggered event. With time, the foreground level C returns to the background level, D, but the occurrence of another trigger event at time E causes the foreground level F again. The trigger events are caused by cosmic originating events. By using a measurement window W, timed to start with the trigger event and have a limited duration, it is possible to obtain a foreground level count or count rate. By using a measurement window X it is possible to obtain a background count. The window X may be positioned to start a time Y after the trigger event, for no further trigger event has occurred, and again has a limited duration. The trigger events are detected by the scintillators 7.

FIG. 3a shows the small count rate observed in the foreground channels and a low count rate in the background channels. Using the foreground and background values illustrated in FIG. 3a, it is possible to determine a ratio for the two, foreground divided by background. With the detector space empty, a series of measurements give generally consistent ratio values (lower left cluster of diamonds in FIG. 4a and in FIG. 4b).

In FIG. 2b the same neutron response is considered with time, but with the presence of a small mass of a high atomic number material which is also a spontaneous emitter of neutrons due to its radioactivity, such as low level enriched uranium. In the case of uranium, the major component is ²³⁸U and this is a neutron emitter and so the count rate is increased in all measurement channels, as can be seen in FIG. 3b when expressed in counts per trigger (the non-shaded bars) and in FIG. 3c when expressed as a count rate (the non-shaded bars). The high atomic number material causes a general increase in the neutron response because the high atomic number material interacts with the muons etc to a greater degree. Hence, the foreground value will be increased; C′ is slightly greater than C. However, the background value is also increased due to the presence of the uranium and the neutrons it emits (A′ is greater than A). As the ratio is defined by the foreground divided by the background, the increase in background significantly decreases the value of the ratio. This is particularly apparent in FIG. 4b (the squares in clusters to the right).

In FIG. 2c, the same neutron response is considered with time, but with the presence of a high atomic number material, such as lead, in the detection location 1. The high atomic number material causes a general increase in the neutron response in the foreground channels because the high atomic number material interacts with the muons etc to a greater degree. Hence, the foreground value will be increased; C″ is greater than C. As the background value does not vary significantly due to the presence of the lead (A equals A″), the value of the ratio increases. Again, a series of measurements give generally consistent ratio values (upper cluster of plus's in FIG. 4b).

The presence of alternative high atomic number materials has a similar impact, for instance for tungsten (dots in FIG. 4a) or concrete (triangles in FIG. 4a). These together with the lead values (crosses in FIG. 4a) form the upper cluster.

In FIG. 2d, the same neutron response is considered with time, but with the presence of a high atomic number neutron emitting material, such as uranium, present in a small mass, along with the same mass of lead as in FIG. 2c. The presence of the two high atomic number materials, particularly the larger mass of lead, increases the foreground value. However, both the foreground and the background values are increased by the neutrons emitting by the radioactive material itself, the uranium; hence C′″ is greater than C, but A′″ is also greater than A. Because the emitted neutrons from the radioactive material are generally consistent in level with time, both the background and the foreground are increased by the same amount. As a proportion, the impact is greater on the background and this results in the ratio of the two taking lower values where the high atomic number radioactive material is present.

When a series of measurements are taken for different masses of low level enriched uranium, a consistent set of ratios for the uranium are obtained (squares in FIG. 4a) but with increasing count rates reflecting the increased amount of uranium in each (left to right in FIG. 4a, 20 g, 50 g, 100 g and 300 g low level enriched uranium, LEU). The ratio is sensitive enough to detect even small amounts of radioactive material caused neutrons in the count. This is so even where the variation in the neutron count is small compared with the other variation caused by a high atomic number material being present.

FIG. 3b shows the variation in neutron count with time from the trigger, taken from experimental measurements with an empty chamber (the equivalent of FIG. 2a), 65 kg of lead (the equivalent of FIG. 2c) and 4 kg of uranium (the equivalent of FIG. 2b). In this instance, the foreground value is obtained by considering channels 0, 1, 2, 3 and 4 which occur after the trigger event. In this instance, the background value is obtained by considering channels 10 to 99 (only channels 0 to 20 are illustrated). The channels each correspond to 50 microseconds in duration. As can be seen, the background value is equivalent in the case of the empty and lead example. In the case of the lead and uranium examples, a much higher foreground value is observed than for the empty example. Only in the uranium example is the background value also present at an elevated level.

In an alternative form, it is possible to consider channels −5 to −1 (not shown) to establish the background value.

FIG. 3c shows the variation in neutron count with time from experimental measurements in similar instances to those of FIG. 3b, namely with an empty chamber (the equivalent of FIG. 2a), two blocks of lead and four blocks of lead (both the equivalent of FIG. 2c) and 4 kg of uranium (the equivalent of FIG. 2b).

Again referring to FIG. 4b, this shows the variation in the measured ratio and measured neutron count rate for a series of measurements of an empty chamber and the results obtained with increasing amounts of high Z material (lead) and uranium present. For the empty chamber a series of measurements give generally consistent ratio values (marked by diamonds). The magnitude of ratio the increases linearly with an increasing mass of the high Z material, (marked by +). Adding such material also causes a small increase in the measured neutron count rate as additional cosmic ray induced neutrons are generated. The presence of alternative high atomic number materials has a similar impact, for instance for tungsten or steel measurements would lie on the same gradient (as shown in FIG. 4a). When a series of measurements are taken for different masses of low level enriched uranium marked, (left to right in FIG. 4b, 20 g, 50 g, 100 g, 300 g, 500 g and 1 kg of LEU), the measured neutron count rate increases. As the magnitude of the background will depend on the uranium mass a series of measurements of increasing uranium mass will result in decreasing ratio values (the squares in FIG. 4b).

Experimental observations indicate muon and other such event frequencies of 1 per cm² per minute. By using suitable sized detectors, it is possible to register 100-200 trigger events each second.

As mentioned above, FIGS. 4a and 4b represent a plot of the ratio, the foreground level divided by the background level, against neutron count rate for various materials. The different ratios obtained clearly distinguish the high atomic number radioactive material (uranium) from the high atomic number non-radioactive material (such as lead or tungsten). The foreground values distinguish a high atomic number value material from a low atomic number material. Hence an effective approach for detecting high atomic number radioactive materials is provided. The plot of the two variables against one another provides a particularly useful way of separating the materials according to their mass and radioactivity characteristics.

In the results shown in FIGS. 4a and 4b, there is spread in the data points at least in part because of variations in atmospheric pressure between experiments. An increase in pressure corresponds to a denser atmosphere and results in a reduction in the number of high energy particles reaching the detection location 1 and hence a reduction in the number of neutrons generated which can be detected. Lower atmospheric pressures give rise to higher numbers of muons and the like, together with consequentially increased numbers of neutrons. Even normal atmospheric pressure changes due to weather, as well as geographic changes due to altitude, can have a material impact.

FIG. 5 shows the variation in observed neutron count rate against pressure with the empty detection location and with the detection location provided with a mass of lead. By coupling the instrument to a barometer or other pressure measuring approach, it is possible to use the atmospheric pressure measured to correct the observed counts to pressure corrected accounts. In this way, closer grouping of the data points is obtained and the level of detection is improved

FIG. 7a shows the ratio of two counts, designated by the applicant the “ship” ratio, against neutron count rate with lead provided in the detection location for a series of short measurements performed in the measuring location.

FIG. 7b shows the linear effect of air pressure on the measured neutron count rate, in a similar manner to FIG. 5.

FIG. 7c shows the same data as FIG. 7a with the neutron count rate corrected for variation in atmospheric pressure using the linear relationship shown in FIG. 7b. This reduces the spread of the data corresponding to the measured response to high Z materials and allows the definition of a “boundary” line. (diagonal rising from left to right). Points lying above the “boundary” line which show an increased neutron count rate, show an accompanying increase in the ratio, indicating that the additional neutron signal is associated with cosmic ray interaction. Points lying below the line show an increase in neutron signal that is not fully accounted for by cosmic ray interactions and so indicate the presence of radioactive material. This example shows the cluster of points that would be observed when a small neutron source (such as uranium) was added to the empty container. This demonstrates how the presence of such material can be identified as distinct from the presence of high Z materials.

The “boundary” line of the type illustrated can be obtained by computer or experimental modelling to account for the impact of the investigation location, the detectors and the physical arrangement in which the detectors and/or investigation location are provided relative to one another. This modelling or calibration could take into account the floor material(s) at the investigation location, the height of the detectors above that floor, the degree to which the investigation location and/or detectors are shielded and the environmental factors around the investigation location. Hence the boundary line position and/or gradient may vary between investigation locations. The container type, container size and characteristics and/or components expected in the volume of material may impact upon the modelling or calibration.

In general, the “boundary” line is established using longer measurement times than will be used to consider unknown volumes of material. The expected scatter arising from shorter measurement times for unknown samples is still established to be such that the correct position relative to the boundary line for a volume of material is obtained with the required degree of confidence, however.

In general, a short time period for initial measurement may be supplemented by a longer time period measurement, when the initial measurement indicates the presence or possible presence of radioactive material. For larger containers in particular, it is to be expected that the container will be considered through a scanning approach or segment by segment measurement approach.

The process may provide an indication of the absence or presence or uncertainty on the radioactive material content for the volume of material. The process may, potentially additionally, provide an indication of the absence or presence or uncertainty on the high Z material content for the volume of material.

Moving beyond an indication of absence/presence, by considering the ratio value and the neutron count rate value combination against calibration data it is possible to convert the results into a mass of radioactive material. Spectroscopy may be used to identify one or more emission energies so as to identify the radioactive material or materials present and so allow a more accurate assessment of mass where the radioactive material type is not known from other information.

The technique of the present invention is useful in many different scenarios where it is desirable to detect the presence of radioactive material and/or the level or mass of radioactive material.

The sensitivity of the approach is such that an initial measurement time of 100 seconds is sufficient to determine the vast majority of possible material combinations to either be free of high atomic number materials or to have high atomic number materials which are not radioactive. In the material combinations were the position cannot be resolved with this count duration, then a secondary count duration of 1000 seconds is sufficient to resolve the position and distinguish between the remaining combinations. Masses of uranium at the 1 kg level and below are easily detected using the approach.

With reference to the type of arrangement shown in FIG. 1, the present invention can be used to inspect large volumes of matrix for the presence of radioactive material. For instance, ISO-freight or other large containers of waste may be generated during the decommissioning of a site which has handled radioactive material. The present invention offers a screening process for inspecting such containers to see if they contain radioactive material or not. The subsequent handling of the waste may differ depending on whether or not radioactive material is detected. Similar arrangements could be used to inspect vehicle borne containers. The container could be driven into the detection location and an analysis could be performed. Such a detection location could be provided at an entry or exit point to an area. Because of the low scan times required, it is possible to configure the instrument to perform the scan as the vehicle is driven through at low speed.

Detectors and the analysis of the present invention are sensitive enough to consider radioactive material even when it is associated with very large masses of other high atomic number materials. Detection is possible even at some distance from the radioactive material.

Where radioactive material is detected, then other investigations, measurements or other actions may be taken with respect to the material itself, matrix it is in, container carrying it or vehicle transporting it.

1. A method for investigating a volume of material for of interest material potentially associated therewith, the method comprising:
providing an investigation location;
providing a first detector, the first detector generating first signals;
providing a second detector, the second detector generating second signals;
providing a volume of material at the investigation location;
detecting a first signal from the first detector and starting a first measurement period; detecting first signals from the first detector and/or second signals from the second detector during the first measurement period;
starting a second measurement period at a second time;
detecting first signals from the first detector and/or second signals from the second detector during the second measurement period;
processing the signals detected during the first measurement period and the second measurement period to give a characteristic value, the value indicating one or more of the possible combinations of radioactive material and the volume of material and/or high atomic number material and the volume of material.

2. A method for investigating a volume of material for radioactive material potentially associated therewith, the method comprising:
providing an investigation location;
providing a first detector, the interaction of cosmic rays and/or one or more types of particle generated by cosmic rays with the first detector causing the first detector to generate first signals;
providing a second detector, the interaction of one or more types of emission from radioactive material with the second detector causing the second detector to generate second signals;
providing a volume of material at the investigation location;
detecting a first signal from the first detector caused by the interaction of cosmic rays and/or one or more types of particle generated by cosmic rays with the first detector, starting a first measurement period at a first time relative to the first signal;
detecting first signals from the first detector and/or second signals from the second detector during the first measurement period;
starting a second measurement period at a second time;
detecting first signals from the first detector and/or second signals from the second detector during the second measurement period;
processing the signals detected during the first measurement period and the second measurement period to obtain their ratio, the value of the ratio indicating a possibility, wherein the possibility is one or more of the following possibilities:
a) the presence of radioactive material associated with the volume of material; or
b) the absence of radioactive material associated with the volume of material; or
c) uncertainty as to whether there is radioactive material associated with the volume of material; or
d) the presence of high atomic number material associated with the volume of material.

3. A method according to claim 1 in which the the ratio is considered together with a other value by considering the value for the ratio against the other value obtained for the second measurement period.

4. A method according to claim 3 in which the method further includes considering the value for the ratio against the other value obtained for the second measurement period to establish the possibility applying.

5. A method according to claim 4 in which the method further includes considering the value obtained from considering the value for the ratio against the other value obtained for the second measurement against one or more bands or areas, a band or area applying for:
the possibility of the presence of radioactive material associated with the volume of material;
the possibility of the absence of radioactive material associated with the volume of material;
the possibility of uncertainty as to whether there is radioactive material associated with the volume of material;
the possibility of the presence of high atomic number material associated with the volume of material.

6. A method according to claim 1 in which observed ratio and/or value and/or plot is compared with an expected ratio and/or value and/or plot, the comparison providing an indication, for instance a warning, where the observed ratio and/or value and/or plot exceeds the expected and/or is below the expected, or more preferably where it exceeds the expected plus a margin and/or is below the expected minus a margin.

7. A method according to claim 1 in which the ratio and/or the one or more other values, such as for the second measurement period, vary according to a variable and a correction is applied, the correction being in respect of the pressure detected during the first and/or second measurement period and/or the correction being in respect of the mass of the volume of material and/or part thereof.

8. A method according to claim 1 in which the investigating location is provided with one or more first detectors above the investigating location and/or one or more first detectors to one or more sides of the investigating location and/or one or more second detectors above the investigating location and/or one or more second detectors to one or more sides of the investigating location.

9. A method according to claim 1 in which the second detector produces a signal on interacting with one or more of an alpha particle, a beta particle, a gamma ray, a neutron, an X-ray or a fission fragment.

10. A method according to claim 1 in which the first detector produces a signal on interacting with a proton, an electron or an atomic nuclei, particularly where that is a cosmic ray and/or is generated by the interaction of a cosmic ray with the Earth's atmosphere and/or in which the first detector produces a signal on interacting with a muon or meson, particularly where generated, directly and/or indirectly, by the interaction of a cosmic ray with the earth's atmosphere and/or in which the first detector produces a signal on interacting with a neutron, particularly where generated by a cosmic ray and/or where generated by a particle generated by a cosmic ray.

11. A method according to claim 1 in which the first detector does not produce a signal on interacting with one or more of an alpha particle, a beta particle, a gamma ray, a neutron, an X-ray or a fission fragment, when those are produced by a radioactive decay process, particularly when arising from the investigation location and/or volume of material.

12. A method according to claim 1 in which the first signal from the first detector caused by the interaction of cosmic rays and/or one or more types of particle generated by cosmic rays with the first detector is a trigger signal, the trigger signal starting the first measurement period.

13. A method according to claim 1 in which the signals detected during the first measurement period are equated to the cosmic ray caused signals and radioactive material in the volume of material caused signals and background caused signals.

14. A method according to claim 1 in which the second measurement period starts at a second time relative to the first signal and/or the second measurement period starts at a second time relative to a trigger signal.

15. A method according to claim 1 in which the signals detected during the second measurement period are equated to the radioactive material in the volume of material caused signals and background caused signals.

16. A method according to claim 1 in which the method includes a determination of the mass of the volume of material and the mass is used to correct one or more of the values used in the method and/or is used to determine one or more of the values used in the method

17. A method according to claim 1 in which the method includes a determination of the density of the volume of material and the density is used to correct one or more of the values used in the method and/or is used to determine one or more of the values used in the method.

18. A method according to claim 1 in which the method includes, based upon the possibility identified, one or more decisions being made about the volume of material, the decision being one or more of: a decision to allow the volume of material past a location; a decision to detain the volume of material at a location; a decision to conduct one or more further investigations.

19. Apparatus for investigating a volume of material for of interest material potentially associated therewith, the apparatus comprising:
an investigation location;
a first detector, the first detector providing first signals;
a second detector, the second detector providing second signals;
electronics and/or computer software for handling a first signal from the first detector, electronics and/or computer software for starting a first measurement period;
electronics and/or computer software for detecting first signals from the first detector and/or second signals from the second detector during the first measurement period; electronic and/or computer software for starting a second measurement period at a second time;
electronics and/or computer software for detecting first signals from the first detector and/or second signals from the second detector during the second measurement period;
one or more processors for the signals detected during the first measurement period and the second measurement period to give a characteristic value, the value indicating one or more of the possible combinations of radioactive material and the volume of material and/or high atomic number material and the volume of material.

20. Apparatus for investigating a volume of material for radioactive material potentially associated therewith, the apparatus comprising:
an investigation location, at which, in use, a volume of material is provided;
a first detector, the interaction of cosmic rays and/or one or more types of particle generated by cosmic rays with the first detector causing the first detector to generate first signals;
a second detector, the interaction of one or more types of emission from radioactive material with the second detector causing the second detector to generate second signals; electronics and/or computer software for handling a first signal from the first detector caused by the interaction of cosmic rays and/or one or more types of particle generated by cosmic rays with the first detector, electronics and/or computer software for starting a first measurement period at a first time relative to the first signal;
electronics and/or computer software for detecting first signals from the first detector and/or second signals from the second detector during the first measurement period; electronic and/or computer software for starting a second measurement period at a second time;
electronics and/or computer software for detecting first signals from the first detector and/or second signals from the second detector during the second measurement period;
one or more processors for the signals detected during the first measurement period and the second measurement period to obtain their ratio, the value of the ratio indicating a possibility, wherein the possibility is one or more of the following possibilities:
a) the presence of radioactive material associated with the volume of material; or
b) the absence of radioactive material associated with the volume of material; or
c) uncertainty as to whether there is radioactive material associated with the volume of material; or
d) the presence of high atomic number material associated with the volume of material.
